(19) United States
(12) Patent Application Publication
(10) Pub. No.: US 2012/0295595 A1
(43) Pub. Date: Nov. 22, 2012

(54) Integrated Alcohol Detection And Mobile Communication Apparatus And Method

(76) Inventors: Ron I. Gibori, Chicago, IL (US); Aaron Webber, Orem, UT (US); Kelechi Agada, Chicago, IL (US); Girish Raghavendra Pai, Chicago, IL (US)

(21) Appl. No.: 13/475,095

(22) Filed: May 18, 2012

Related U.S. Application Data
(60) Provisional application No. 61/487,574, filed on May 18, 2011.

(51) Int. Cl. H04W 88/02; H04W 4/00

(52) U.S. Cl. 455/414.1; 455/556.1

(57) ABSTRACT

The alcohol level of a first user is measured. The sensed alcohol level is transmitted to a mobile device. At the mobile device, first options associated with the sensed alcohol level of the first user are presented to a second user and changes in the blood alcohol level of the first user are detected. Second options are presented to the second user in response to detecting the changes.

### CROSS REFERENCE TO RELATED APPLICATION

This patent claims benefit under 35 U.S.C. §119 (e) to U.S. Provisional Application No. 61/487,574 entitled “Integrated Alcohol Detection and Mobile Communication Apparatus and Method” filed May 18, 2011 having attorney docket number 8354-99603-US the content of which is incorporated herein by reference in its entirety.

### TECHNICAL FIELD

This application relates to alcohol detection devices and mobile communication devices.

### BACKGROUND OF THE INVENTION

Alcohol consumption is common in society today. Many citizens enjoy alcoholic beverages and these beverages are served at various restaurants, bars, parties, sporting events, and so forth. However, too much alcohol consumption can be unhealthy and/or dangerous in many circumstances. For example, when operating a motor vehicle too much alcohol consumed by a driver impairs the driver and can result in death or serious injury to the driver and occupants of the vehicle and other vehicles. Various authorities (e.g., national, state or local governments) have set limits for the amount of alcohol in the blood, above which it is illegal to operate a motor vehicle. Other alcohol limits have been set with respect to others not operating vehicles (e.g., alcohol limits for pregnant woman or workers, to mention two examples). Alcohol measurement devices (e.g., breathalyzers, blood analysis devices, and so forth) have been constructed to measure the alcohol level in the blood to determine whether these limits have been exceeded.

As mentioned, various types of alcohol devices have been used to determine the alcohol level present in the blood of a person. For example a police officer may conduct a breath test on a motorist who has been stopped. If the alcohol level is too high and is above legal limits, the motorist may be arrested or physically removed from the vehicle. Others may wish to know their blood alcohol level for health reasons.

### BRIEF DESCRIPTION OF THE DRAWINGS

For a more complete understanding of the disclosure, reference should be made to the following detailed description and accompanying drawings wherein:

FIG. 1 comprises a block diagram of the system according to various embodiments of the present invention;

FIG. 2 comprises a flowchart of an approach for presenting options to a user according to various embodiments of the present invention; and

FIG. 3 comprises a block diagram of an apparatus with a dynamic interface for presenting options to a user according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Integrated alcohol detection and mobile communication devices and methods of operating these devices are provided. The approaches described herein can involve or utilize mobile device applications and, more particularly, provide dynamic interfaces for mobile application users.

As used herein, “mobile device” means any mobile communication device such as a cellular phone, personal digital assistant, pager, laptop, tablet, or personal computer to mention a few examples. The device is typically a wireless communication device. As used herein, “alcohol detection device” refers to any device that is capable of determining the alcohol level present in a human being (e.g., in the blood level of a human). For example, various breathalyzers and blood measurement analysis devices can be used. Other examples are possible.

In some aspects, the approaches described herein pertain to an external mobile accessory device that incases a breathalyzer sensor for the purpose of processing and transmitting Blood Alcohol Concentration (BAC) measurements to smartphones (and/or other mobile devices). A smartphone (and/or other mobile devices) utilizes an operating system that allows it to run mobile device applications in conjunction with data processed and transmitted from the external breathalyzer device. As used herein, “mobile device application” refers to any software such as a game, business program that is run on a mobile device such as a mobile phone, tablet, or PDA, to mention a few examples. Other examples of mobile device applications are possible.

The approaches described herein provide a system solution to help users monitor the level of alcohol in their blood and provide several media for displaying the information to the user or transmitting it over the cellular (or other types of) network. The present approaches often involve the creation, processing, possessing, transmitting and/or displaying of such information from a mobile accessory device for the purpose of utilizing mobile device applications.

After the information is sent over a network, various actions can occur or be undertaken. For example, the information could be sent to an internet social network to friends of a user and the friend can take an action (e.g., send a taxi to pick up the user). The information can also be sent to the police, employers, or any other entity where it can be further processed, displayed, or acted upon in a variety of different ways. The information can be stored and processed into reports or further analyzed for other purposes.

To take one example, a breathalyzer can be used as the measurement device. If a determination is made that the friend is intoxicated, a user can have the option to send their friend (e.g., as a gift) a ride (e.g., using a taxi) home. For example, a credit card (e.g., from the user or friend) may be processed to pay for the ride. Other payment methods can also be used.

In some aspects, systems, methods, and computer readable media for providing improved user interfaces for mobile device applications are provided. In some embodiments, when a user inputs data from initiating the mobile accessory device, the interface can determine what the format is for that data, such as an analog or digital format. The mobile device application interface can transmit, process and present the end user with a series of icons, which for instance can be in the form of a toolbar, that are useful for the selected data format. The icons provided can be a predetermined set of icons selected by the designer of the user interface or can be a custom set of icons preselected by a user of the interface.

Mobile device applications often have graphic user interfaces featuring icons that a user can “click” using an interface device. These icons are often graphic representations of application features available to the user for customizing content that was generated using the mobile device application in conjunction with external mobile accessory device. For example, icons may represent various blood alcohol levels.

Methods, systems, and computer readable media for providing dynamic interfaces for mobile device applications are provided. These methods, systems, and computer readable media include various ways of presenting application features to a user, as well as ways of simplifying the use of certain application features.

In one of these embodiments, a system or apparatus for providing a dynamic interface for a mobile device application includes a display configured to display within the dynamic interface one or more first options associated with a first user action type, and a processor coupled to the display, wherein the processor is configured to detect a change from the first user action type to a second user action type, remove the one or more first options from within the dynamic interface when the change is detected, and display within the dynamic interface one or more second options associated with the second user action type on the display. Various options may be provided for various blood alcohol levels. For example, a blood alcohol level of 0.02 may involve a first action or option (e.g., informing the drinker to stop drinking) while a level of 0.08 may involve another action or option (e.g., calling a taxi cab). The actions or options described may require manual intervention (e.g., the user may be required to press an icon) or may be automatically generated.

In others of these embodiments, a mobile device application is implemented on a system. The system includes means for displaying one or more first options associated with a first user action type in the dynamic interface, means for detecting a change in the user action type from the first user action type to a second user action type, means for removing one or more first options from within the dynamic interface when the change is detected, and means for displaying one or more second options associated with the second user action type in the dynamic interface. The latter means may be implemented via a processor and associated programming. In this respect, if a user has a blood alcohol level below a first threshold, no action may be taken. If the level is between a first and second level, another action may be taken (e.g., a warning may be displayed to the user. And, if above the second level another action may be taken (e.g., a taxi) may be sent to for the user. The actions described may require manual intervention (e.g., the user may be required to press an icon) or may be automatically generated.

The overall system enables users to monitor their alcohol level using an alcohol measurement sensor. The sensor is any type of sensing or measurement apparatus or arrangement that is capable of measuring the alcohol level present in a human. The sensor analog output is converted into a digital output that is processed by a microcontroller (MCU). The MCU processes the information using an alcohol level measurement algorithm and transmits the data to a smartphone using a standard interface (such as USB, Headphone, Wireless Network or Bluetooth). At the smartphone (or other wireless device), a mobile device application will be implemented that translates the data from the interface and processes it before displaying to the end user or transmitting the information over one or more networks.

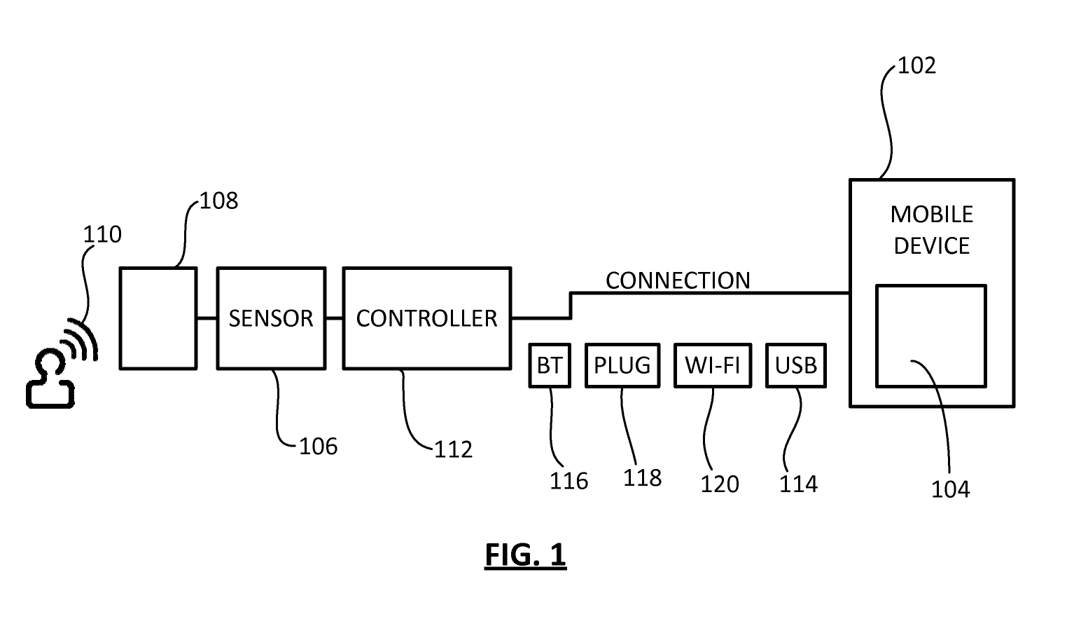

FIG. 1 is a diagram showing the smartphone and block diagram of the breathalyzer components and various connection methods to a smartphone (or other mobile device). More specifically, FIG. 1 depicts a typical mobile smartphone 102 used to transmit and receive communication signals in conjunction with a portable breathalyzer device. A visual display 104 on the mobile smartphone is used to activate the mobile device application. The portable breathalyzer device is used for detecting the presence of ethanol in user's breath using an alcohol sensor 106. For convenience, the portable breathalyzer device has a mouth piece 108 into or onto which a user 110 exhales. The output of the sensor is processed through a microprocessor or controller 112, and processed data is passed through to a productive smartphone application through a USB connection 114 or Bluetooth device 116 or Audio jack/head set 118 or Wi-Fi 120 to dynamically generate a series of options for the user to select.

It will be appreciated that the above example is described in conjunction with a smartphone and a breathalyzer. However, it will be appreciated that any type of alcohol measurement device may be used. It will be further appreciated that any type of mobile wireless device (and in some cases wired device) may be used.

The information involving blood alcohol level of a user can not only be displayed to the user (at the mobile device) but can be transmitted to other systems and users. For example, other users can see the alcohol level (e.g., displayed through an internet social network) and take appropriate actions. Alerts can also be issued when blood alcohol limits are reached. These may be displayed at the user's own device and at other remote devices (that are connected to a network where the information is sent).

In other aspects, a system that enables users to analyze their alcohol level using a smartphone dongle (i.e., a small piece of hardware that connects to a mobile device) or other accessory device such as mobile device covers with integrated breath analyzer and a microcontroller to process the information and transmit the data to the smartphone is provided. In one example, the smartphone display presents the alcohol level thresholds using pre-selected icons to display from the productive application. In other examples, the smartphone display to provide the information to the end user of a mobile device mobile application.

In some aspects, the cellular network is used to transmit the alcohol level information to others (e.g., friends of the user, the taxi cab service). In other aspects, Wi-Fi media are used to transmit the alcohol level data from the mobile device to others.

In some examples, an audio jack is used to transmit the alcohol level data. In other examples, the USB connector is used to transmit the alcohol level data. In still other examples, a Bluetooth protocol is used to transmit the alcohol level data. In some examples, the data is transmitted over a Wi-Fi network.

In other examples, the systems described herein enable users to analyze their alcohol level using a Bluetooth-compatible device with an integrated breath analyzer and a microcontroller to process the information and transmit the data to the smartphone. In some examples, the smartphone display presents the alcohol level. In some aspects, the smartphone display is used to provide the information to users. In other examples, the system uses the cellular network to transmit the alcohol level information to others. In some aspects, the cellular network is used to transmit the alcohol level information to others. In other aspects, Wi-Fi media are used to transmit the alcohol level data to others. This can be accomplished by transmitting the information from the mobile device across different types of networks such as cellular networks and the Internet to mention two examples. In some examples, an audio jack is used to transmit the alcohol level data. In other examples, a USB connector is used to transmit the alcohol level data. In other examples, a Bluetooth connection is used to transmit the alcohol level data. In some aspects, the data is transmitted to a social network.

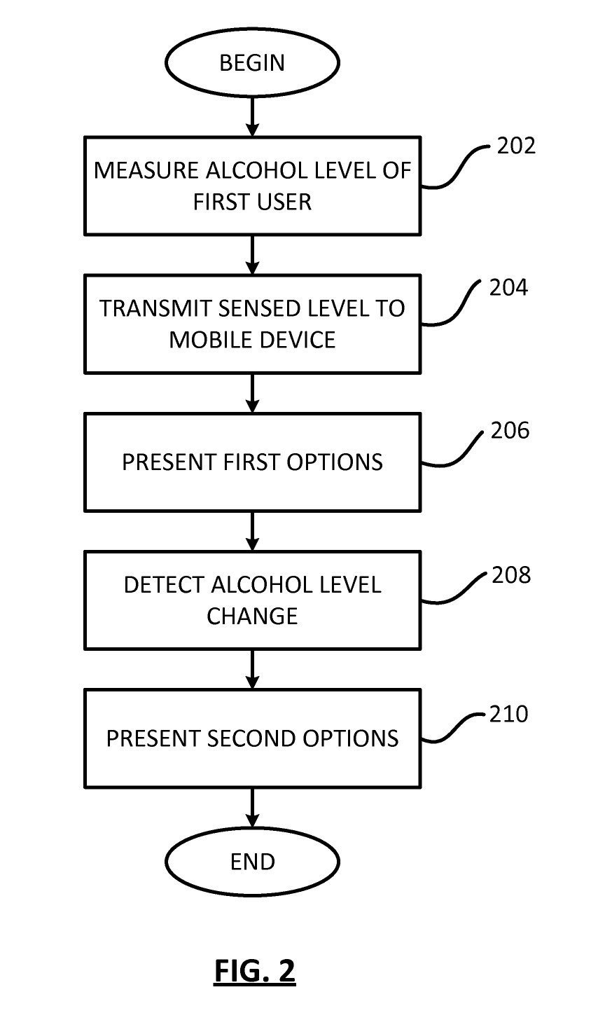

Referring now to FIG. 2, one example of an approach for presenting options to a user using a mobile apparatus is described. At step 202, the alcohol level of a first user is measured. At step 204, the sensed alcohol level is transmitted to a mobile device. At step 206 and at the mobile device, one or more first options associated with the sensed alcohol level of the first user are presented to a second user, for example, using a dynamic interface. At step 208 and at the mobile device, changes in the blood alcohol level of the first user are detected and one or more second options (possibly replacing all or some of the first options) are presented to the second user in response to detecting the changes, for example, using the dynamic interface.

In some examples, the first and second users are the same user. In other aspects, the options are presented using graphical icons.

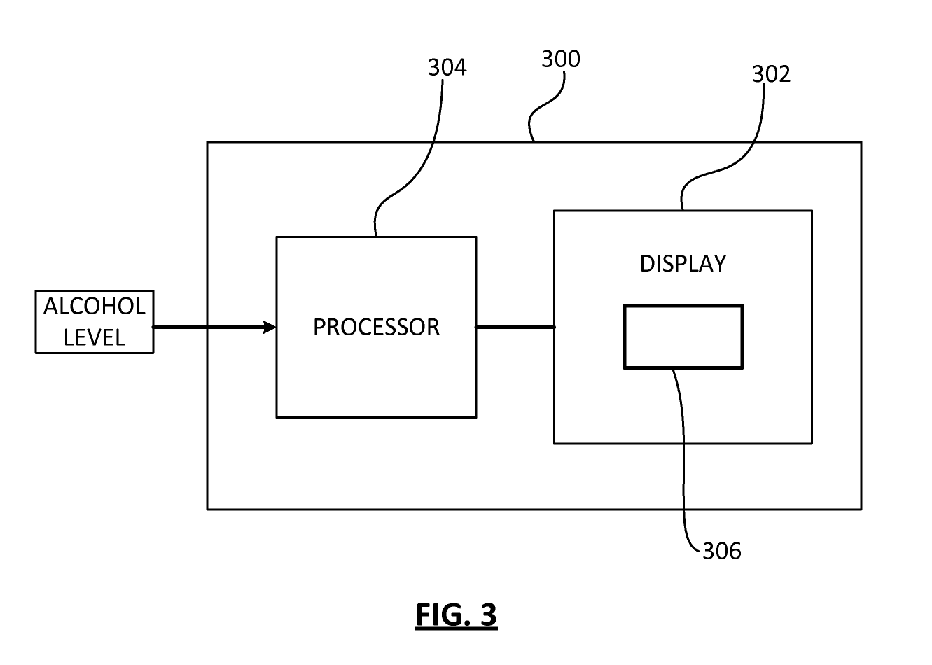

Referring now to FIG. 3, one example of an apparatus 300 with a dynamic interface for a mobile device application is described. The apparatus 300 includes a display 302 and a processor 304. The processor 304 may be configured to receive at an input the blood alcohol level of a user (via an appropriate interface) from an appropriate alcohol measuring device as described elsewhere herein. The processor 304 may also be configured with an output, which is coupled (via an appropriate communication interface) to one or more communication networks. In this way, the processor may transmit alerts or other messages to other users or devices via the one or more communication networks.

The display 302 includes icons 306 and the icons 306 represent (or allow the user to select) one or more first options associated with a first user action type. The first action type is related to a first alcohol level of a user.

The processor 304 is coupled to the display 302. The processor 304 is configured to detect a change from the first user action type to a second user action type. The second action type is related to a second alcohol level of a user. The processor 304 is further configured to remove the one or more first options (represented by icons 306) when the change is detected and present one or more second options (represent by new icons 306) associated with the second user action type.

Various options may be provided for the detection or sensing of various blood alcohol levels. For example, a blood alcohol level of 0.02 may involve a first action or option (e.g., informing the drinker to stop drinking) while a level of 0.08 may involve another action or option (e.g., calling a taxi cab). The actions or options described may require manual intervention (e.g., the user may be required to press an icon) or may be automatically generated (e.g., a message may be automatically sent).

It will be appreciated that many of the approaches described herein can be implemented using computer instructions stored on a computer media (e.g., a computer memory device) and executed by a processing device (e.g., a microprocessor). As mentioned, the type of computer memory and the type of processing device can also be varied to suit the needs of the user or the system.

Preferred embodiments of this invention are described herein, including the best mode known to the inventors for carrying out the invention. It should be understood that the illustrated embodiments are exemplary only, and should not be taken as limiting the scope of the invention.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. An apparatus for providing a dynamic interface for a mobile device application, the apparatus comprising:
a display, the display configured to present one or more first options associated with a first user action type, the first action type being related to a first alcohol level of a user; and
a processor coupled to the display, wherein the processor is configured to detect a change from the first user action type to a second user action type, the second action type being related to a second alcohol level of a user, the processor further being configured to remove the one or more first options from the display when the change is detected and present on the display one or more second options associated with the second user action type on the display.

2. The apparatus of claim 1, wherein the first and second options comprise one or more icons.

3. The apparatus of claim 1, wherein the first and second options are selected from the group consisting of display of a message to the user and transmission of a message to a third party.

4. The apparatus of claim 1, wherein selected ones of the first and second options are manually generated.

5. The apparatus of claim 1 wherein selected ones of the first and second options are automatically generated.

6. The apparatus of claim 1, wherein the processor is configured to receive the first blood alcohol level of the user and the second blood alcohol level of the user from a measurement device.

7. A method of presenting options at a mobile device to a user, the options responsive and related to the alcohol level of the user, the method comprising:
measuring the alcohol level of a first user;
transmitting the sensed alcohol level to a mobile device;
at the mobile device:
presenting first options associated with the sensed alcohol level of the first user to a second user; and
detecting changes in the blood alcohol level of the first user and presenting second options to the second user in response to detecting the changes.

8. The method of claim 7, wherein the first and second options comprise one or more icons.

9. The method of claim 7, wherein the first user and the second user are the same user.

10. The method of claim 7, wherein the first user and the second user are different users.

11. The method of claim 7, further comprising transmitting an alert to a third party from the mobile device upon detecting the changes.

12. The method of claim 11, wherein the third party is selected from the group consisting of: the police, a taxi, and a third user.

13. The method of claim 11, wherein the transmitting comprises transmitting the alert over a cellular communication network to a third party.

14. The method of claim 11, wherein the transmitting comprises transmitting the alert over the Internet to a third party.
